(19) United States
(12) Patent Application Publication
(10) Pub. No.: US 2020/0348674 A1
(43) Pub. Date: Nov. 5, 2020

(54) METHOD AND SYSTEM FOR BUILDING MANAGEMENT

(71) Applicant: BSH HAUSGERAETE GMBH, MUENCHEN (DE)

(72) Inventors: CHRISTOPH SOELLNER, MUENCHEN (DE); ROMANO OTTE, MUENCHEN (DE); MATTHIAS ROECKL, OTTOBRUNN (DE)

(21) Appl. No.: 16/865,599

(22) Filed: May 4, 2020

(30) Foreign Application Priority Data
May 3, 2019 (DE) 102019206393

(51) Int. Cl. G05D 1/02; G05D 1/00

(52) U.S. Cl. CPC G05D 1/0212; G05D 2201/0215; G05D 1/0094

(57) ABSTRACT

A method and a system for managing a building. An autonomously moving platform traverses the building. The building is scanned with a scanning facility attached to the platform. A three-dimensional free space in the building is determined based on the scan.

### CROSS-REFERENCE TO RELATED APPLICATION

This application claims the priority, under 35 U.S.C. § 119, of German patent application DE 10 2019 206 393, filed May 3, 2019; the prior application is herewith incorporated by reference in its entirety.

### BACKGROUND OF THE INVENTION

### Field of the Invention

The invention relates to a technology for managing a building. In particular the invention relates to determining a free space in the building.

A building comprises a number of spaces on a common level, the spaces being connected to one another by means of doors or passageways. If there are a number of levels, they are generally connected to one another by means of elevators or stairs. The building can be for private or commercial use. In both instances people can bring objects into the building, take objects away or arrange them differently within the building. In some instances a wall can be moved or a passage can be blocked or created, in particular when the walls are lightweight, as is usually the case in some offices.

A free space between the objects in the building can therefore change shape or size frequently. To meet all needs arising from the use of the building it may be expedient to manage the free space. For example segments of the free space can be assigned to individual people, with each person managing the space assigned to them themselves. Certain segments can also be provided for common use. In another example an automatic floor processing machine, for example an autonomous vacuum cleaner or an autonomous floor cleaner, can schedule its operation more effectively based on a determined free space.

Japanese published patent application JP 2005153104 describes an autonomous robot, which is designed to patrol through a building.

### SUMMARY OF THE INVENTION

It is an object of the present invention to improve the management of a space enclosed in a building.

With the above and other objects in view there is provided, in accordance with the invention, a method for managing a building. The novel method comprises the following steps:

traversing the building with an autonomously moving platform;

scanning the building with a scanning facility attached to the platform; and

determining a three-dimensional free space in the building based on the scan.

According to the invention the three-dimensional space delimited by a building and the objects present therein can be determined automatically and used to manage the building. The free space can in particular be determined so frequently that it is possible to respond promptly to a change in its shape, size or location. This allows the determined free space to be used in different ways.

In contrast with prior art technology, which takes account substantially only of a floor area, on which for example an autonomous floor processing robot can operate, the three-dimensional space of the building is preferably determined. The three-dimensional space can be determined such that it can be used by a person. A prototype person of average size can be assumed for this purpose, in particular a person used in standard architectural considerations. Thus the free space can in particular have an adequate height clearance for the person, allowing them to move without bending. If at one point the space is narrower than a predetermined width, so the person cannot pass through without turning or touching a side delimitation, such a point can be marked as impassible or be excluded from the determined free space. The platform is preferably smaller than the assumed person in every spatial direction, so that it can traverse a larger part of the building than the free space determined for the person.

In one particularly preferred embodiment it can be determined whether a safety requirement is met by the shape or size of the free space. Safety requirements usually exist in the form of building or operating regulations and generally serve to ensure the safety of people and things in the region of the building. The building can thus be checked automatically for compliance with regulations. For example if a route that has to be kept clear is obstructed or closed, for example because furniture or some other object has been positioned there, it is possible to respond before use of said route might be compromised in the event of an emergency, thereby improving the safety of the building and the people therein.

In Germany, for example, escape routes have to be designed according to ASR A2.3 of the “Technical rules for workplaces” in commercially used buildings. These rules describe, inter alia, lengths and widths of escape routes. Numerous regulations relating to routes and connections also have to be complied with for private buildings or residences.

The safety requirement can comprise for example compliance with a minimum width for a corridor. A corridor generally comprises a segment of the building, which can be passed through. The corridor can correspond to a hallway, which is essentially a room delimited by walls, which can be passed through to go from one room adjoining another to another adjoining room. However the corridor can also be formed in a different manner. For example in an open-plan office a corridor can be formed between partitions or furniture, or in a warehouse it can be formed between parked objects such as pallets or vehicles. The corridor can be delimited by a wall on one side. In a living room or workroom the corridor can also be formed for example between furniture, appliances or plants. The corridor can be part of an escape route. The safety requirement can determine a minimum required width of the corridor based on a number of people who have to use the corridor in an emergency. This number can be a function of structural conditions and the use of the building or a segment thereof. The minimum width is generally determined in relation to a maximum number of people passing through and a number, length and location of alternative routes.

The safety requirement can comprise the length of a route from a predetermined point in the building to an exit. It can thus be ensured that an escape route within the building is not excessively long. A safety requirement usually means that there is no point in the building from which the length of an escape route exceeds a predetermined dimension.

The free space can generally be determined from the platform or from a remote point. The remote point can comprise for example a server or a service, in particular abstracted in a cloud. The remote point can collate information from a plurality of platforms which can move around in the building.

In one embodiment the determined three-dimensional free space is stored, in particular together with details of acquisition time. This allows it to be demonstrated later that one or more predetermined safety requirements were met at a predetermined time or how they may not have been met. It can be determined at any time what state the free space in the building was in and how old the most recent available information is. If for example an emergency occurs requiring evacuation of the building, it is possible to determine current route functionality. It can also be determined where in the building people could be present based on the free space.

In a further embodiment compliance with individual safety requirements can be stored, so that the state of compliance is available for each of a predetermined number of requirements. Unprocessed or partially processed data can also be stored, for example to allow subsequent verification of compliance with safety requirements. In one embodiment for example raw data, which is produced as the building is scanned, can be stored; in a further embodiment areas or volumes derived therefrom; and in a further embodiment segments of the free space determined therefrom.

It is also preferred that the stored information is protected cryptographically against subsequent modification. For example it can be demonstrated to an insurer or authority that a claimed state was present at a predetermined time. The information can be digitally signed for example by a trust center. In a further embodiment the information is stored in a revision-proof manner. Revision-proof generally means that predetermined statutory requirements for storage are met. The requirements can relate to type, quantity, format, frequency and/or protection of the data against subsequent change or falsification.

If non-compliance with a safety requirement is determined at a point in the building, a signal can be supplied to indicate the point (i.e., location). The signal can also comprise a determination time and/or the safety requirement not complied with. The signal can be stored and/or supplied to a responsible person. It is thus possible to respond immediately to non-compliance, for example by instructing the person to inspect the point and/or to ensure that the safety requirement is met. If for example an escape route is blocked or obstructed, it can be re-opened by the person. Measures can be taken to prevent future recurrence of the same problem.

The free space can comprise a door and the safety requirement can comprise a predetermined opening state of the door. Particular doors can be usually closed or usually open. A fire door for example can be closed when not in use. If the fire door is open for a longer period, a corresponding safety regulation may be infringed.

In a further variant of the invention possible equipping of the determined free space with an element of a predetermined collection of furniture or appliances can be determined. To this end the determined free space can be made accessible to a party which supplies such objects. The information can preferably be released or withheld in a fine-grained manner by one or more people, in particular users or owners of the building. A recipient circle for the information can also preferably be determined in a fine-grained manner. The information can be protected digitally against unauthorized forwarding, for example by means of cryptography, steganography or watermarking. A format for the information is preferably disclosed and can follow an XML definition for example.

Different parties can access the same or different information. For example a first party could arrange houseplants in the building, a second party pictures or posters on the walls and a third party drapes or a floor covering. In one embodiment the determined free space can also be used before occupation or taking up use of a segment of the building to plan furnishing or the integration of furniture or appliances, in particular in a kitchen. The accuracy of the information supplied about the free space can also be indicated here. If more accurate information is required than that available, it can be determined for example by a specialist on site.

It is generally preferred that the free space adjoins a floor. It is generally assumed that the floor is flat, it being possible to tolerate thresholds or steps up to a predetermined height. In a further embodiment the free space can also adjoin the bottom of an object, for example an item of furniture. A third party can supply a candle holder or vase for example, which can be positioned either on the floor or on another object.

It is also generally preferred that an area of the free space adjoining a wall is determined. The area can be important for the supply of wall decoration. It may be required that a wall can adjoin a floor.

According to a further aspect of the present invention a system for managing a building comprises an autonomously moving platform, which is designed to traverse the building; a scanning facility attached to the platform for scanning the surroundings of the platform; and a processing facility, which is designed to determine a three-dimensional free space in the building based on the scan.

The processing facility can be designed in particular to execute a method described herein wholly or partially. To this end the processing facility can comprise a programmable microcomputer or microcontroller and the method can be available in the form of a computer program product with program code means. The computer program product can also be stored on a machine-readable data medium. Features or advantages of the method can be similarly applied to the apparatus or vice versa.

The platform can comprise a position sensor and be designed to determine a distance from a delimitation of the surroundings of the platform. In particular a distance sensor can also be used, which only scans in a one- or two-dimensional manner. The scans can be joined together to allow a segment of the free space to be determined, based on the position of the platform, which can comprise one orientation.

Other features which are considered as characteristic for the invention are set forth in the appended claims.

Although the invention is illustrated and described herein as embodied in a building management method and a system for safety monitoring, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagram of an exemplary system;

FIG. 2 shows a flow diagram of an exemplary method;

FIG. 3 shows an exemplary view of objects in a building; and

FIG. 4 shows a schematic floor plan diagram of a building with a free space determined by way of example.

### DETAILED DESCRIPTION OF THE INVENTION

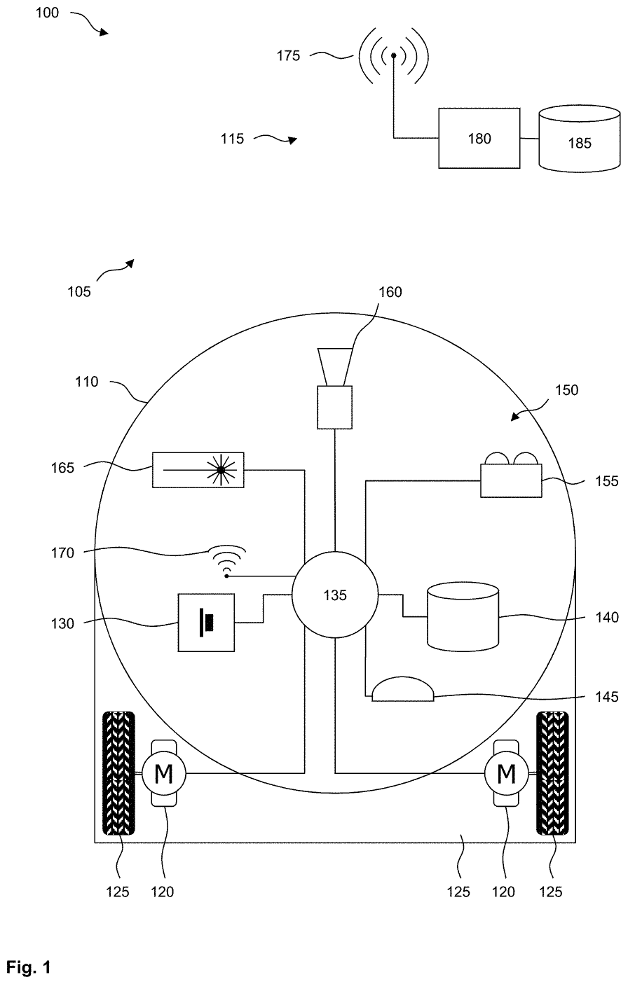

Referring now to the figures of the drawing in detail and first, particularly, to FIG. 1 thereof, there is shown a system 100, which is designed in particular to manage a building 105. The system 100 comprises a platform 110, which can move autonomously in one segment of the building 105 at least. The platform 110, which may also be referred to as a vehicle, may be in the form of a floor processing machine, for example a vacuum cleaning or floor cleaning robot. The platform 110 can also serve another, additional purpose, for example carrying an object. In one embodiment the platform 110 is only designed to scan the interior of the building 105. The building may be a room, an apartment or a house. If used commercially, the building 105 can be, for example, an administration site, a warehouse or a production site. The system 100 can also comprise a remote point 115, which can be sited at any location or can be abstracted from the location in a cloud.

The platform 110 is shown by way of example in the form of a vacuum cleaning robot, functional elements for vacuum cleaning not being shown in FIG. 1. To drive the platform 110 one or more, preferably electric, drive motors 120 are provided, which generally act on a floor by way of drive wheels 125. An energy storage unit 130 is preferably included to supply energy, in particular being implemented as a battery.

A processing facility 135 is preferably provided to process information. The processing facility 135 can control the drive motors 120 to move the platform 110 around the building 105. Map information relating to the building 105 can be stored in an optional storage apparatus 140. The map information can be supplemented, updated or modified by the processing facility 135. An optional positioning facility 145 is designed to determine a position and/or orientation of the platform 110 in the building. The positioning facility 145 can comprise an odometer, an inertial platform or an acceleration sensor or can operate for example actively or passively based on radio waves. In a further embodiment the position can also be determined based on images of the surroundings of the platform 110.

At least one scanning facility 150 is provided to scan the surroundings. Three exemplary scanning facilities 150 are shown in FIG. 1: a radar sensor 155, a camera 160 and a LiDAR sensor 165 or a speckle pattern sensor. The radar sensor 155 is designed to emit radar waves and receive reflected radar waves. Based on the radar waves it is possible to determine distances from points in predetermined directions. The LiDAR sensor 165 operates in a similar manner, using light instead of radar waves, generally coherent light, which can be supplied by a laser. A rotating mirror can deflect the light supplied in a predetermined manner to scan a predetermined region. Distances between a number of points and the LiDAR sensor 165 can also be determined here. With the speckle pattern sensor a laser projects a defined, for example highly quadratic, dot pattern into the space in front of the sensor. A camera, which reacts sensitively to the spectrum of the laser, records the image of the resulting pattern of laser dots, the distance from the sensor itself being worked out based on the distance between the laser dots. Here too the sensor output is a point cloud at the current site of the sensor system.

The camera 160 can operate passively based on the light present or it may include a light source. A spectral range, in which the camera 160 operates, can be predetermined and can comprise a visible and/or invisible spectrum. In one embodiment the camera 160 comprises a depth camera, based for example on the determination of distances based on the propagation speed of light (TOF, time of flight), or based on stereoscopy.

In a further embodiment a point cloud is generated purely optically by analyzing motion vectors in a video data stream, referred to as pixel displacement. This attempts to calculate a perspective based on the distance moved by image blocks or even macro blocks from one image to a subsequent image of the video data stream. For technical reasons the methodology generally functions better for the close range due to greater displacement of the pixel data and therefore higher resolution. The method is only comparable with that of image acquisition using a stereo camera in that instead of two offset images being recorded simultaneously by two cameras, here two temporally offset images are recorded with just one camera. The offset is preferably determined by way of the distance covered by the platform 110 from the positioning system of the platform 110. The necessary movement of the camera 160 is brought about here by the movement of the entire sensor unit itself, a point cloud resulting here too, which can be constantly improved with continued movement of the platform 110.

The point cloud thus generated is generally located and oriented in a machine coordinate system for a defined position of the platform 110 in the building 105 and generally has to be translated into a coordinate system tailored to the building 105 with the aid of additional information, in particular a position of the platform 110 at the time of the scan.

A wireless communication facility or unit 170 can be provided for communication with another unit, in particular for communication with the remote point 115. The remote point 115 preferably also comprises a communication facility 175, as well as a processing facility 180 and an optional storage facility 185.

The platform 110, or vehicle, is configured to traverse the building 105 autonomously, scanning it in the process. The traversal is preferably controlled based on the scan so that every free space in the building 105 can be scanned where possible. The free space can then be determined by size, shape and/or location in the building 105 from the platform or remote point 115 based on the scans. A three-dimensional model of the free space in the building 105 is optionally determined. It can then be verified whether the free space meets one or more predetermined safety requirements. The safety requirements can be permanently predetermined. Verification can also be performed in relation to a free space determined at a previous time. A result of the verification can be stored. If a safety requirement is not met, a message to this effect can be output. Information about the free space can also be made accessible to a third party, for example by means of a dedicated interface and/or using a predetermined data format.

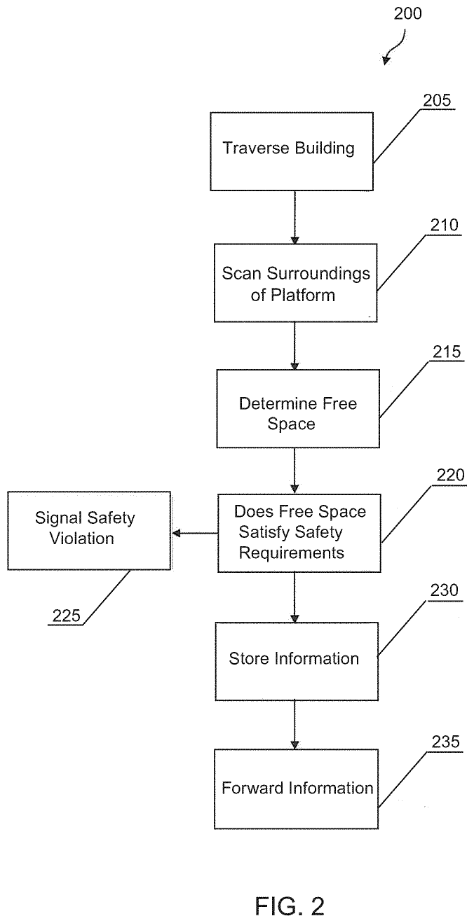

FIG. 2 shows a flow diagram of an exemplary method 200, which can be executed in particular based on a system 100. In a step 205 the building 105 can be traversed by one or more platforms 110. At least one platform 110 moves through the building 105 preferably autonomously in this process. Movement can take place during the performance of a further task, for example floor processing. The platform 110 can navigate through the building 105 based on existing map information. The platform 110 preferably determines a region it can traverse based on map information and/or a local sensor and where possible independently bypasses a region it cannot traverse.

Even if the platform 110 does not have to process certain regions of the building 105, it preferably traverses the building 105 as comprehensively and a completely as possible to produce the most complete scan possible. This means specifically that the platform 110 preferably either covers a floor area of the building 105 as completely as possible so that it traverses an outer boundary of a traversable region of the building 105, or it penetrates so far into a traversable region based on a scan that new scan results can be expected. The actual scan can take place in a step 210, which preferably happens concurrently with step 205 and can be executed continuously or intermittently.

In a step 215 a free space in the building 105 can be determined based on the scans that have taken place. The determination can be performed during or after scanning and alternatively from the platform 110 or the remote point 115, to which scan results or partially processed scan results can be sent by the communication facilities 170, 175. In one embodiment the determination takes place “interactively” in that the platform 110 is controlled as a function of a previous determination of at least some of the free space so that information still required for a further determination is scanned specifically in the building 105. For example a region, in which information has not yet been scanned with sufficient density or accuracy, is approached specifically by the platform 110 and scanned using one of the scanning facilities 150. The free space is preferably determined in three dimensions, as far as it can be seen from the platform 110. The free space is also preferably determined such that a (fictional) person can walk freely through the free space or a predetermined vehicle can traverse the space, where appropriate in compliance with predetermined safe distances. A point where the free space for example forms a narrower corridor than could be used freely by the person or vehicle can be considered to be impassible. In another embodiment the free space can be determined as accurately as possible and verification of compliance with predetermined dimensions can take place in another step.

The platform 110 should be able to scan with sufficient repeat accuracy. The determined measurements can be mapped onto a measuring system tailored to the building 105 for example based on characteristic dimensions on the building 105. Such a dimension may exist in a passageway between walls or other fixed landmarks. In one embodiment absolute dimensions of an, in particular empty, segment of the building 105 are known and a scan of the segment by the platform 105 is compared with the known dimensions to determine scaling, which can also be applied in a different segment of the building 105. Scaling can be determined using an adaptive filter or algorithm.

In an optional step 220 it can be determined whether the free space meets one or more predetermined safety requirements. It can in particular be determined whether predetermined dimensions of passages, rooms or segments of the building 105 are complied with. This can include verification of whether two adjoining segments of the building 105 are connected or separated; in particular whether a door between the segments is usually closed or permanently open. A dimension to be complied with can be indicated in the form of a fixed region, for example in relation to a predetermined object “there must be 90 cm free width to the left of the object”. The dimension can also be indicated by algorithm, for example “there must be a total of 90 cm free width to the left and right of the object”. The safety requirements can be derived in particular from statutory regulations applicable to the building 105.

If a safety requirement is not met, a corresponding signal can be supplied in a step 225. The signal can comprise an alarm for example, which can be sent by SMS or email to a responsible person, for example a superintendent or security service. An image or video data stream can also be sent, which has preferably been recorded at a point in the building 105 where the safety requirement is not met, for example where a corridor is too narrow.

In a step 230 determined information can be stored. The information can comprise in particular the determined free space, a time when the platform 110 performed the acquisition, a determination time based on scans, a result of the verification of compliance with a safety requirement and/or notification of a supplied signal. The information can be partially or fully protected, preventing subsequent modification or forwarding. A history of information relating to previous determinations is preferably stored.

In a step 235 information about the determined free space can be supplied to a party. To this end the information can be supplied in particular to a predetermined interface. It can also be converted to a predetermined format for transmission. The third party can receive information once or regularly, for example based on time or an event. In different embodiments a predetermined frequency, level of detail or accuracy can be specified for the information. It is also preferred that all or individual aspects of the information can be released by a person entrusted with the management or use of the building 105.

The person can use the information for example to recommend how the free space should be equipped. This can include recommendations for the positioning of furniture or decorative items, houseplants or household appliances. In one embodiment free vertical areas of the free space in particular are considered and proposals are made for hanging a picture, poster or some other item attached to the wall. The item can also comprise an appliance such as a flat screen or projection screen. It can be specified at what height above a floor area an object to be positioned in the building 105 should be located. For example a vase can stand on the floor or on a table, while a carpet runner is only intended for the floor.

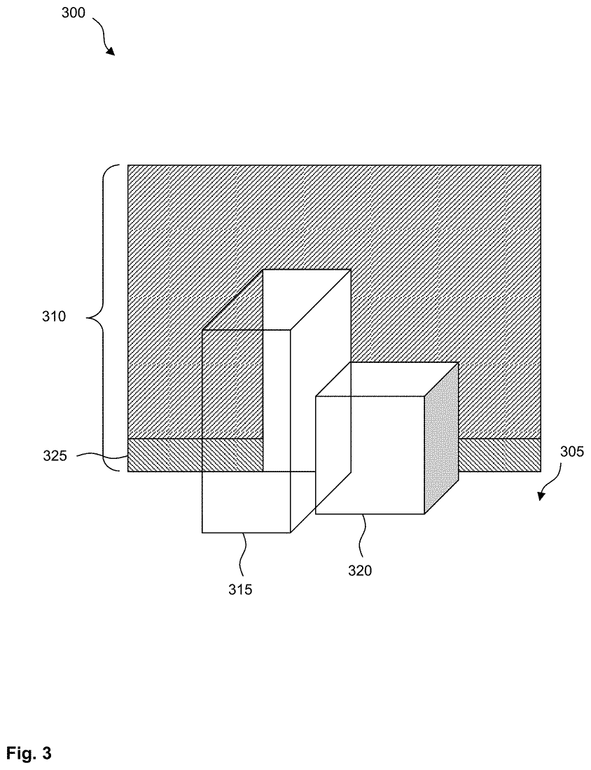

FIG. 3 shows an exemplary view 300 of objects in a building 105. A first object 315 and adjoining it a second object 320 stand on a floor 305 against a wall 310. The platform 110 is on the floor 305 at a certain distance from the wall 310. It uses one of the scanning facilities 150 to determine a number of points in the space, on surfaces of the floor 305, the wall 310 or one of the objects 315, 320. For example points vertically above one another at a maximum distance from the platform 110 may indicate a corner between two walls 310. The fact that the platform 110 can move means a one- or two-dimensional scanning facility 150 can also be used to determine the areas. The points relate to a position and orientation of the platform 110 and with knowledge of their position and/or orientation can be transferred to a coordinate system tailored to the building 105.

Points on common areas can be determined using corresponding algorithms and the area can be interpolated between the points. This means that measurement errors can be reduced by averaging when determining the individual points. Elements such as the floor 305, wall 310 or one of the objects 315, 320 can be determined based on determined areas. In one embodiment a region 325 close to the floor can be determined, which is suitable for a ground-based object such as a cabinet or large vase.

It should be noted that points that were scanned during a previous traverse of the building 105 can also be used to determine an area. Such points are located in particular on a fixed element such as the floor 305 or a wall 310. The more frequently the platform 110 traverses the building 105, the greater the number of points available for determining an area. This largely makes up for any absolute measurement inaccuracy of a scanning facility 150.

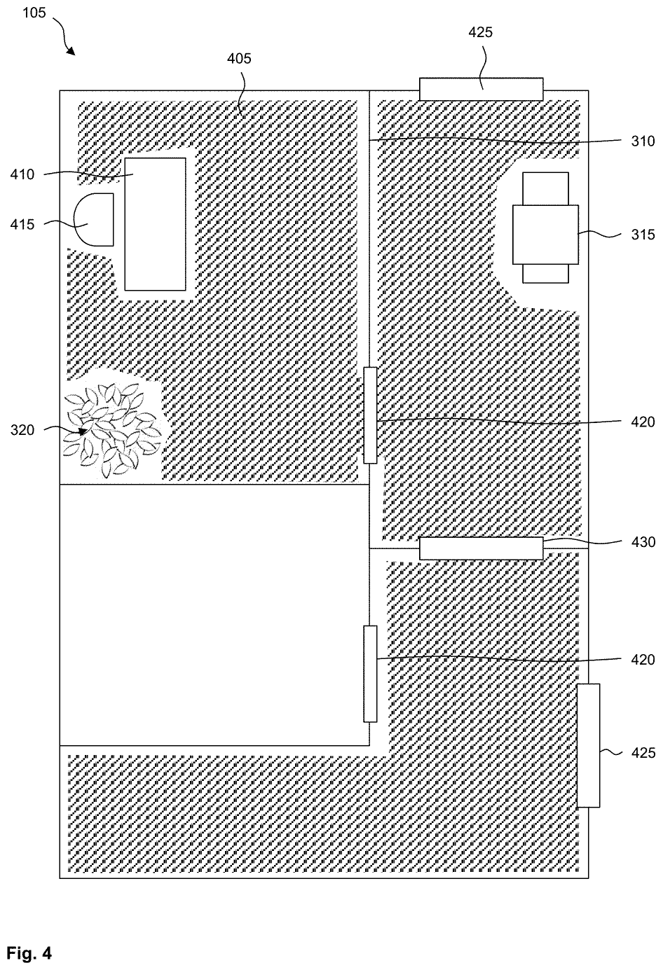

FIG. 4 shows a schematic building 105 with a free space 405 determined by way of example viewed from above. So that the free space 405 can be identified more clearly, it is shown at a certain distance from walls 310 and objects 315, 320. In the present example the first object 315 is a photocopier and the second object 320 is a houseplant. Further objects comprise a table 410 and chair 415. Individual rooms in the building 105 are connected to one another by doors 420, and there are two exits 425.

An escape route can be determined from any point in the free space 405 to one of the exits 425. A maximum escape route length has to be complied with. A minimum escape route width can depend on how many people may have to use the escape route at the same time. This can depend on the size of the segment of the free space 405, from which there are escape routes to the same exit 425 and the number of people for whom the segment is approved. This number can be higher at an event venue than in a warehouse for example.

A fire door 430 divides a passageway into two segments. The fire door 430 is generally provided with an automatic closing mechanism so it can be opened at any time but closes automatically. Obstructing or locking the fire door 430 can infringe a safety requirement. Permanent opening of the fire door 430 can infringe a different safety requirement.

The following is a list of reference numerals used in the above description of the invention with reference to the drawing figures:
100 System
105 Building
110 Platform
115 Remote point
120 Drive motor
125 Drive wheel
130 Energy storage unit
135 Processing facility
140 Storage facility
145 Positioning facility
150 Scanning facility
155 Radar sensor
160 Camera
165 LiDAR sensor
170 Communication facility
175 Communication facility
180 Processing facility
185 Storage facility
200 Method
205 Traverse building
210 Scan surroundings
215 Determine free space
220 Safety requirement met?
225 Supply signal
230 Store information
235 Determine possible content
300 View
305 Floor
310 Wall
315 First object
320 Second object
325 Region close to ground
405 Free space
410 Table
415 Chair
420 Door
425 Exit
430 Fire door

1. A method of managing a building, the method comprising the following steps:
traversing the building with an autonomously moving platform;
scanning the building with a scanning facility attached to the platform; and
determining a three-dimensional free space in the building based on the scanning.

2. The method according to claim 1, wherein the free space is determined as a free space to be used by a person.

3. The method according to claim 1, which further comprises determining whether a safety requirement is met by a shape or a size of the free space.

4. The method according to claim 3, wherein the safety requirement comprises compliance with a minimum corridor width.

5. The method according to claim 4, wherein the safety requirement further comprises a length of a route from a predetermined point in the building to an exit.

6. The method according to claim 3, wherein the safety requirement comprises a length of a route from a predetermined point in the building to an exit.

7. The method according to claim 1, which further comprises storing the three-dimensional free space together with details of an acquisition time.

8. The method according to claim 7, which comprises protecting the stored information cryptographically against subsequent modification.

9. The method according to claim 3, which comprises determining a non-compliance with a safety requirement at a given location in the building and supplying a signal to indicate the location.

10. The method according to claim 3, wherein the free space comprises a door and the safety requirement is a predetermined opening state of the door.

11. The method according to claim 1, which comprises determining a possible equipping of the free space with an element of a predetermined collection of furniture or appliances.

12. The method according to claim 1, which comprises determining an area of the free space adjoining a wall.

13. A system for protecting a building, the system comprising:
an autonomously movable platform, which is configured to traverse the building;
a scanning facility attached to said platform for scanning surroundings of said platform; and
a processing facility configured to receive a scan from said scanning facility and to determine a three-dimensional free space in the building based on the scan.

14. The system according to claim 13, wherein said platform carries a position sensor and said scanning facility is configured to determine a distance from a delimitation of the surroundings of said platform.
